(19) United States
(12) Patent Application Publication
(10) Pub. No.: US 2012/0036859 A1
(43) Pub. Date: Feb. 16, 2012

(54) COMBUSTOR TRANSITION PIECE WITH DILUTION SLEEVES AND RELATED METHOD

(75) Inventors: Richard JOHNSON, Greer, SC (US); Crystal McGee McConnaughhay, Greenville, SC (US); Bryan Wesley Romig, Simpsonville, SC (US)

(73) Assignee: General Electric Company, Schenectady, NY (US)

(21) Appl. No.: 12/855,154

(22) Filed: Aug. 12, 2010

(51) Int. Cl. F02C 1/00; F02C 7/12

(52) U.S. Cl. 60/772; 60/39.83

(57) ABSTRACT

A gas turbine transition piece adapted to carry combustion gases in a hot gas path extending between a gas turbine combustion chamber and a first stage of the gas turbine, includes a hollow duct having a forward end adapted for connection to a combustor liner and an aft end adapted for connection to a first stage nozzle. One or more dilution air holes are located proximate the forward end, the dilution holes each fitted with a hollow sleeve penetrating into the hot gas path within the hollow duct, the hollow sleeves adapted to supply cooling air into the hot gas path.

### BACKGROUND OF THE INVENTION

This invention relates generally to gas turbine combustion technology and, more specifically, to a transition piece construction that promotes uniform cooling of hot gases flowing through the transition piece to the turbine.

It is well known that air-polluting emissions are typically produced in gas turbines burning conventional hydrocarbon fuels. Those emissions are usually oxides of nitrogen, carbon monoxide and unburned hydrocarbons. It is also well known that oxidation of molecular nitrogen is dependent upon the temperature of the hot gases produced by the turbine combustor that flow through a transition piece to the first stage nozzle. The residence time for the reactants at these high temperatures is also a factor in the production of the undesirable emissions.

Various concepts have been proposed and utilized to maintain the reaction zone temperatures below the level at which thermal NOₓ is formed, or by reducing the residence time at high temperatures such that there is insufficient time for the NOₓ formation reaction to go forward, or both. One method of reducing the temperature of the reactants in the combustor is to provide a lean mixture of fuel and air prior to combustion. Thus, dilution air is oftentimes provided within the combustion liner to absorb heat and reduce the temperature rise to a level where thermal NOₓ is not formed. However, in many cases, and even with lean premixed fuel and air, the temperatures are sufficient to produce undesirable emissions.

Dilution air has previously been provided in the transition piece between the combustor and the first stage nozzle. For example, in one prior art construction, dilution holes have been provided at both ends of the transition piece. However, undesirable emissions remain a problem, and it would be desirable, therefore to provide a transition piece design which promotes more effective and uniform cooling of combustion gases flowing between the turbine combustor and the turbine first stage.

### BRIEF DESCRIPTION OF THE INVENTION

In accordance with an exemplary but nonlimiting embodiment, a gas turbine transition piece adapted to carry combustion gases in a hot gas path extending between a gas turbine combustion chamber and a first stage of the gas turbine, comprises a hollow duct having a forward end adapted for connection to a combustor liner and an aft end adapted for connection to a first stage nozzle; one or more dilution air holes proximate the forward end and substantially equally spaced from one another, each of the one or more dilution holes fitted with a hollow sleeve penetrating into the hot gas path within the hollow duct, the hollow sleeve adapted to supply cooling air into the hot gas path.

In another nonlimiting aspect, a gas turbine transition piece adapted to carry combustion gases in a hot gas path extending between a gas turbine combustion chamber and a first stage of the gas turbine comprises a hollow duct having a substantially cylindrical forward end adapted for connection to a combustor liner and an aft end adapted for connection to a first stage nozzle; one or more dilution air holes proximate the forward end and substantially diametrically opposed to one another, the dilution holes each fitted with a substantially cylindrical hollow sleeve penetrating into the hot gas path within the hollow duct, the substantially cylindrical hollow sleeve having a tapered edge at an outlet end thereof.

In still another nonlimiting aspect, the invention provides a method of promoting temperature uniformity in a gas turbine transition piece extending between a gas turbine combustion chamber and a first stage of the gas turbine, the transition piece comprising a hollow duct having a forward end adapted for connection to a combustor liner and an aft end adapted for connection to a first stage nozzle, the method comprising providing one or more cooling air dilution holes in the transition piece; and inserting a sleeve in each of the one or more cooling air dilution holes, each sleeve penetrating into an interior space of the hollow duct, thereby, in use, enabling cooling air to more uniformly mix with hot gases within the hollow duct to provide enhanced temperature uniformity in the transition piece.

### BRIEF DESCRIPTION OF THE DRAWINGS

FIG. 1 is a simplified partial, exploded assembly view for a portion of a gas turbine including a lengthwise cross section of a transition piece incorporating a dilution sleeve in accordance with an exemplary embodiment;

FIG. 2 is an enlarged detail of the dilution sleeve shown in FIG. 1; and

FIG. 3 is a section taken along the line 3-3 of FIG. 1, but with a second dilution sleeve added.

### DETAILED DESCRIPTION OF THE INVENTION

With reference now to FIG. 1, a conventional turbine combustor liner 10 includes a generally cylindrical, segmented body having a forward end (not shown) and an aft end 12. The forward end is typically closed by liner cap hardware that also mounts one or more fuel injection nozzles (not shown) for supplying fuel to the combustion chamber within the liner. The aft end 12 of the liner is typically secured to a tubular transition piece 14 that supplies the hot combustion gases to the first stage 16 of the turbine.

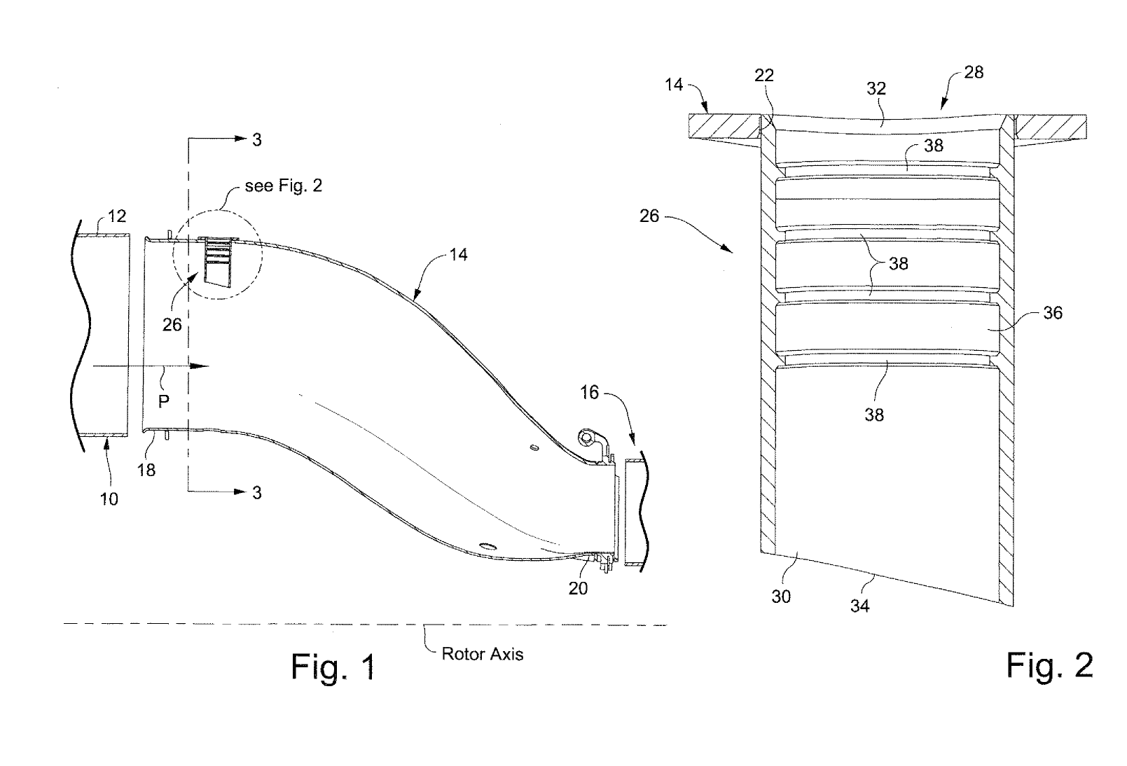

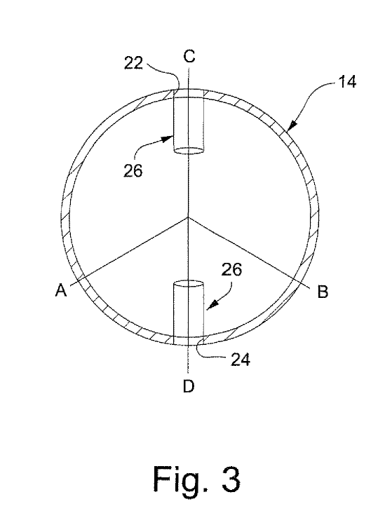

In an exemplary but nonlimiting embodiment of this invention, the gas turbine transition piece 14 is in the form of a hollow duct having a forward end 18 adapted for connection to the combustor liner and an aft end 20 adapted for connection to the first stage nozzle. The manner in which the transition piece 14 is connected at its opposite ends is well understood and needs no further discussion here. In accordance with an exemplary but nonlimiting embodiment, one or more dilution air holes 22, 24 (see FIGS. 2 and 3) are formed in the transition piece, or hollow duct 14, proximate or adjacent the forward end 18 of the hollow duct, and substantially equally spaced from one another in a circumferential direction (see FIG. 3). The dilution holes 22, 24 are each fitted with a hollow dilution sleeve 26 that penetrates into the interior of the hollow duct 14 and thus, in use, into the hot gas path indicated by the flow arrow P. These dilution sleeves 26 are adapted to supply cooling air (e.g., compressor discharge air) deep into the hot gases in the hot gas path. The hollow dilution sleeves 26 may be fixed in place by welding or other suitable means (for example, by providing a bushing in the dilution hole with a shoulder adapted to receive an annular flange or shoulder on the sleeve). The surfaces of the dilution sleeves 26, particularly the outer surfaces, may be coated with a thermal barrier coating to protect the dilution sleeves from the hot gas in the transition piece or hollow duct 14

With particular reference to FIG. 2, each hollow sleeve 26 may be substantially cylindrical or aerodynamic in shape, with an inlet end 28 and an outlet end 30. The inlet end 28 may be beveled as shown at 32 to provide smoother flow into the sleeve, and the outlet end may be straight or formed with a tapered or sloped edge 34 that allows deeper penetration into the hot gas path. An interior surface 36 of each hollow sleeve is formed with at least one and preferably more several annular turbulator rings 38 that are axially spaced along the length of the sleeve, as best seen in FIG. 2.

In the exemplary but nonlimiting embodiment, each of the hollow dilution sleeves 26 may be about 3 inches long, with a length-to-diameter ratio of between about 1.5 and 2.0. The tapered edge 34 may extend inwardly in the direction of flow at an angle of less than twenty (20) degrees (e.g., twelve (12) degrees) relative to the turbine rotor axis. The plural axially-spaced turbulator rings 38 may have a substantially square or triangular cross section with a height (i.e., the extent of radial projection into the dilution sleeve 26) of about 0.075 inch (or between about five and ten percent of the interior radius of the sleeve 26), and they are axially spaced by between about five and six times the height of the turbulator (e.g., about 0.425 inch) along the length of the sleeve.

It will be appreciated that variations in the sleeve construction (including dimensions) and specified location of the sleeves 26 on the transition piece 14 are within the scope of the invention. For example, the sleeves 26 may be oval-shaped, teardrop-shaped, airfoil shaped (with trailing edges on the downstream side) or other suitable shapes that do not create undue stress or hot points. In addition, the one or more of dilution holes 22, 24 could be moved from the 12 o'clock and 6 o'clock positions shown in FIG. 3 to the 9 o'clock and 3 o'clock or other diametrically opposed positions. It is currently believed that the best results are achieved when the dilution sleeves 26 are diametrically opposed, but there may be applications where that relationship may also vary. The cross-sectional shapes and dimensions of the turbulator rings 38 may also vary with specific applications. Finally, while the dilution sleeves 26 are shown adjacent a forward end of the transition piece 14, they are not limited to that location. Current understanding of the invention suggests that location in at least the forward half of the transition piece 14 is preferred.

It will also be appreciated that the invention is applicable in both new and retrofit situations. In the case of a retrofit, where in a nonlimiting example, the transition piece may normally have three smaller dilution holes indicated at locations A, B and C in FIG. 3, two of the three existing dilution holes (A and B, for example) would be closed with the hole at location C enlarged to receive its respective dilution sleeve 26, and a new hole drilled at location D. In the case of a new installation, one or more dilution holes would be drilled at dramatically opposed locations as described above. In both cases, the combined cross-sectional area of the two dilution holes should be substantially equal to the cross-sectional area of the three dilution holes currently used in the prior design.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A gas turbine transition piece adapted to carry combustion gases in a hot gas path extending between a gas turbine combustion chamber and a first stage of the gas turbine, the transition piece comprising a hollow duct having a forward end adapted for connection to a combustor liner and an aft end adapted for connection to a first stage nozzle; one or more dilution air holes proximate said forward end and substantially spaced from one another, each of said one or more dilution air holes fitted with a hollow sleeve penetrating into the hot gas path within said hollow duct, said hollow sleeve adapted to supply cooling air into the hot gas path.

2. The gas turbine transition piece of claim 1 wherein each said hollow sleeve is substantially cylindrical or aerodynamic in shape.

3. The gas turbine transition piece of claim 1 wherein each said hollow sleeve is formed with a straight or tapered edge at an outlet end of said hollow sleeve.

4. The gas turbine transition piece of claim 2 wherein an interior surface of each said hollow sleeve is formed with at least one annular turbulator ring.

5. The gas turbine transition piece of claim 4 wherein said at least one turbulator ring comprises plural axially spaced turbulator rings.

6. The gas turbine transition piece of claim 1 wherein said forward end of said hollow duct is substantially cylindrical or aerodynamic in shape, and wherein said hollow sleeves are at positions proximate to said forward end.

7. The gas turbine transition piece of claim 2 wherein each of said hollow sleeves has a length to diameter ratio of between 1.5-2.

8. The gas turbine transition piece of claim 3 wherein said tapered edge extends inwardly in a direction of gas flow at an angle of 20 degrees or less relative to a rotor axis of the gas turbine.

9. The gas turbine transition piece of claim 5 wherein said plural axially-spaced turbulator rings have a substantially square cross section and extend radially into said hollow sleeve about between five and ten percent of an interior radius of said hollow sleeve.

10. The gas turbine transition piece of claim 9 wherein said plural axially-spaced turbulator rings are axially spaced by between five and six times the height of the turbulator.

11. A gas turbine transition piece adapted to carry combustion gases in a hot gas path extending between a gas turbine combustion chamber and a first stage of the gas turbine, the transition piece comprising a hollow duct having a substantially cylindrical forward end adapted for connection to a combustor liner and an aft end adapted for connection to a first stage nozzle; one or more dilution air holes proximate said forward end and substantially spaced from one another, said dilution holes each either fitted with a hollow sleeve penetrating into the hot gas path within said hollow duct, said substantially cylindrical hollow sleeve having a tapered edge at an outlet end thereof.

12. The gas turbine transition piece of claim 11 wherein an interior surface of each said substantially cylindrical hollow sleeve is formed with at least one annular turbulator ring.

13. The gas turbine transition piece of claim 12 wherein said at least one turbulator ring comprises plural axially spaced turbulator rings.

14. The gas turbine transition piece of claim 13 wherein said plural axially-spaced turbulator rings each have a substantially square or triangular cross section and extend radially into said sleeve between five and 10 percent of an interior radius of said substantially cylindrical hollow sleeve.

15. The gas turbine transition piece of claim 11 wherein each of said substantially cylindrical hollow sleeves has a length to diameter ratio of between 1.5-2.

16. A method of promoting temperature uniformity in a gas turbine transition piece extending between a gas turbine combustion chamber and a first stage of the gas turbine, the transition piece comprising a hollow duct having a forward end adapted for connection to a combustor liner and an aft end adapted for connection to a first stage nozzle, the method comprising:
a) providing one or more cooling air dilution holes in the transition piece; and
b) inserting a sleeve in each of said one or more cooling air dilution holes, each sleeve penetrating into an interior space of said hollow duct, thereby, in use, enabling cooling air to more uniformly mix with hot gases within said hollow duct to provide enhanced uniformity of temperature in said transition piece.

17. The method of claim 16 wherein said sleeve is substantially cylindrical or aerodynamic in shape.

18. The method of claim 17 including forming said sleeve with a tapered or straight edge at an outlet end of said sleeve.

19. The method of claim 17 including forming on an interior surface of said sleeve at least one annular turbulator ring.

20. The method of claim 16 including coating at least an outer surface of said sleeve with a thermal barrier coating to protect said sleeve from the hot gases within the hollow duct.
